(19) United States
(12) Patent Application Publication
(10) Pub. No.: US 2007/0274087 A1
(43) Pub. Date: Nov. 29, 2007

(54) Interchangeable simulated neon light tube assemblies and related accessories for use with lighting devices

(76) Inventor: Michael A. Herold, Akron, OH (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 11/707,446

(22) Filed: Feb. 16, 2007

Related U.S. Application Data
(63) Continuation-in-part of application No. 11/124,466, filed on May 5, 2005, now abandoned.

(51) Int. Cl. F21V 7/00

(52) U.S. Cl. 362/516; 362/311; 362/362; 362/546

(57) ABSTRACT

A simulated neon light tube assembly includes an elongated tube having a light diffusing material disposed therein for simulating the appearance of neon lighting. The light tube is used in conjunction with a base portion having a light source disposed therein to provide a lighting device. The light tube assembly of the present invention is preferably closed ended, and is selectively removable from the base portion so that it can, therefore, be replaced easily with another light tube assembly. Modified retaining covers, retaining caps and mounting assemblies are also described.

### TECHNICAL FIELD

The present invention relates generally to a simulated neon light tube assembly and its related components for use with various lighting devices. More particularly, the present invention relates to a closed-ended, simulated neon light tube assembly suitable for use in and selectively removable from a gasless lighting device. Various accessories such as modified retaining covers, modified retaining caps for reflecting light beyond the simulated neon light tube, and modified mounting assemblies are also presented.

### BACKGROUND ART

Battery-operated, gasless lighting devices, such as flashlights, are commonplace throughout the world and well know in the lighting art. More recently, gasless lighting devices of the type having a light source, such as a light emitting diode (LED), disposed within a handle or base and an elongated light tube permanently affixed to the handle or base for generally directing light through the light tube from one end thereof have become popular in the automotive industry as well as the decorative lighting, novelty item and toy industries. The popularity of these lighting devices with elongated light tubes is believed to be based, at least in part, on the recent ability of these light tubes to simulate the characteristics of neon lighting.

“Neon lighting” or “neon light” generally refers to the use of an inert gas, such as neon, that is placed in a clear glass tube and ionized by electrical means such that the electrons in the neon or other gases are charged to provide a unique type of bright, almost fluorescent-like, glowing light. It will be understood that gases other than neon may be employed to create different colors for this type of lighting, but neon is the most commonly known gas, and hence, this type of lighting is commonly called neon lighting. Neon lighting is particularly desirable for its bright glow, thereby allowing objects to be effectively illuminated in the daylight as well as in the dark.

Unfortunately, neon lighting does have some drawbacks. In order to use neon lighting, neon or other inert gases must first be inserted into the tube for use. This may not only be costly, but can also be somewhat dangerous if not performed properly. Once the neon gas is properly introduced in the tube, an electrical transformer or battery must be used to apply and maintain a relatively high voltage to the neon gas so as to ionize the gas. The gas, in turn, will glow within and illuminate the tube.

Because the tubes in which the neon gas is held are made of glass, such tubes are often considered fragile and easily breakable. This presents still another danger to the user of neon lighting, and therefore, neon lighting devices are not recommended as toys for children. In addition, when compared to other types of lighting, neon lighting is quite expensive, especially when the neon lighting is made into a custom design. Thus, when these drawbacks, as well as others, are taken into consideration, many people choose to use other more conventional types of lighting, even though a neon light would result in superior lighting with respect to brightness.

Attempts have been made in the prior art to mimic or simulate neon light with conventional light sources. Initial efforts focused on the use of a transparent tube having an external sleeve of smooth, flexible transparent plastic material fitted and affixed onto the tube to aid in projecting, refracting, or reflecting light from a light source located at one end of the tube. Other efforts used various types of mirrors and lenses to project, refract, or reflect light. While some of these efforts have been partially successful, the results are often efficient or achieved through more difficulty, complexity and expense than actual neon.

Moreover, some of these efforts have failed to produce a substantially uniform distribution of light along the entire length of the tube. To cope with this problem, many of these newer lighting devices use optical fibers in the tube to provide a uniform distribution of light. However, optical fibers disadvantageously must be disposed within the light tube and are, therefore, also susceptible to breakage.

More recently, the art has been advanced with the invention of simulated neon light tube assemblies like those set forth in U.S. Pat. No. 6,726,350 and U.S. Ser. No. 10/792,249. Both the patent and the application, the entireties of the disclosures of which are incorporated herein by reference, generally disclose simulated neon light tube assemblies comprising a light source, namely an LED or LED cluster, electrically connected to a power source to provide light for distribution through a transparent tube having a closed end distal to the light source and an open edge proximate to the light source. A light-diffusing material comprising one or more layers of thin acetate, or like material, which are rolled or stacked to a particular thickness, is inserted into the light tube through the tube's open edge to provide a translucent neon lighting-like effect to the light tube. In use, when the LED illuminates, the light emitted travels through the light tube and disperses through the light diffusing material, which causes an effect that simulates neon light.

Currently, these simulated neon light tube assemblies may replace certain neon lighting devices, such as illuminated license plate covers and running boards in the automotive industry, and have developed new markets in the toy and novelty item industry. With the popularity of the “Star Wars” movies, new “light sabers” or “light swords” have emerged.

While the simulated neon light tubes disclosed in U.S. Pat. No. 6,726,350 and U.S. Ser. No. 10/792,249 have significantly improved the lighting art, there are still many improvements to be made to such a simulated neon light tube which were not and could not have been envisioned by the earlier patent or application. For example, prior art simulated neon light tubes, like all light tubes, are still susceptible to being broken. Even though they are not necessarily made of glass and are not as easily broken as neon light tubes for neon lighting devices, they still be may be cracked or otherwise destroyed. When this occurs, the lighting device is broken as well as well as the lighting tube, and the entire unit must be replaced. Thus, the need exists for a simulated neon light tube that can be replaced with another simulated neon light tube in the same lighting device.

Furthermore, the simulated light tubes disclosed in U.S. Pat. No. 6,726,350 and U.S. Ser. No. 10/792,249 are straight tubes having an LED or LED cluster at one end and a reflector at the other end to reflect light back through the tube. This provides for an even distribution of light along the entire length of the light tube. However, further embodiments of these devices should have the ability to reflect light beyond the closed end of the tube. Thus, the need exists for alternative reflective caps at the end of the light tube distal from the light source.

### SUMMARY OF THE INVENTION

One aspect of the present invention provides for a simulated neon light tube assembly for use with and selectively removable from a lighting device having at least one light source, wherein at least one light source is disposed proximate to one end of the tube assembly, the tube assembly comprising an elongated, transparent tube having a inner surface; a light diffusing film disposed against the inner surface of the tube; a first cap disposed on an end of the tube distal to the light source, the first cap including a reflector at least partially disposed thereon for reflecting light; and an at least partially translucent second cap disposed on an end of the tube proximate to the light source and closing that end of the tube, the second cap separating the light diffusing film from the light source and allowing light to be received into the tube; wherein the first cap and the second cap encapsulate the light-diffusing film within the tube.

Another aspect of the present invention provides a lighting device comprising a base portion; at least one light source disposed within the base portion for emitting light; an elongated light tube having one end attached to the base portion and disposed proximate the light source such that light emitted from the light source will illuminate the light tube, the light tube having an inner surface and including a light diffusing film disposed against the inner surface of the tube; a first cap disposed on an end of the tube distal to the light source, the first cap including a reflective material at least partially disposed thereon for reflecting light; and an at least partially translucent second cap disposed on the end of the tube proximate to the light source and closing that end of the tube, the second cap separating the light diffusing film from the light source and allowing light to be received into the tube; wherein the first cap and the second cap encase the light diffusing film within the tube.

Still another aspect of the present invention provides a mounting assembly for attaching a light tube assembly to a fixed mounting surface, the mounting assembly comprising a mounting bracket attached to the fixed mounting surface and having opposed arms for receiving at least one end of the light tube assembly therebetween; and at least one light source disposed between the opposed arms of the mounting bracket and aligned in a manner to emit light through the one end of the light tube assembly secured in the mounting assembly, such that the light tube assembly will be illuminated.

Yet another aspect of the present invention provides a lighting device comprising a base portion; at least one light source disposed within the base portion for emitting light; and an elongated light tube selectively removable from the base portion and having an inner surface and two closed ends, one end of which is disposed proximate the light source, when disposed in the base portion, such that light emitted from the light source illuminates the tube, and wherein the light tube includes a light diffusing film disposed against the inner surface of the tube such that light illuminating the tube simulates the appearance of neon lighting.

An additional aspect of the present invention provides a lighting device comprising a base portion; at least one light source disposed within the base portion for emitting light; and an elongated light tube having one end attached to the base portion and disposed proximate the light source such that light emitted from the light source will illuminate the light tube, the light tube having an inner surface, the light tube including a light diffusing film disposed against the inner surface of the tube the diffusing film having a rolled total wall thickness from about 0.031 inches to about 0.375 inches; a first cap disposed on an end of the tube distal to the light source; a second cap disposed on the end of the tube proximate to the light source and closing that end of the tube allowing light to be received into the tube, wherein the first cap and the second cap encase the light diffusing film within the tube; and a removable cap having a solid at least partially transparent core having an angled end aligned with the light source, the removable cap including a tube receiving end opposite the angled end configured to selectively receive an end of the light tube distal the light source.

Another aspect of the present invention provides a lighting device comprising a base portion; at least one light source disposed within the base portion for emitting light; and an elongated light tube having one end attached to the base portion and disposed proximate the light source such that light emitted from the light source will illuminate the light tube, the light tube having an inner surface, the light tube including a light diffusing film disposed against the inner surface of the tube the light diffusing film having a rolled total wall thickness from about 0.031 inches to about 0.375 inches; a first cap disposed on an end of the tube distal to the light source; and a second cap disposed on the end of the tube proximate to the light source and closing that end of the tube, allowing light to be received into the tube, wherein the first cap and the second cap encase the light diffusing film within the tube; and a retaining cover having an elongated solid at least partially transparent core with an angled end, the retaining cover configured to be removably attached to the base portion, such that when attached the angled end is aligned with the light source, and the cover encases a portion of the light tube exposed from said base portion.

Still another aspect of the present invention provides a mounting system for mounting an illuminable article assembly to a vehicle having a plurality of retaining cavities, the system comprising a plurality of retention supports, at least one of which houses a light source, each retention support configured to be mounted within one of said retaining cavities; an elongated illuminable article disposed proximate the light source, such that light emitted from the light source will illuminate the illuminable article and having a first end maintained by one retention support, and a second end maintained by a second retention support.

An additional aspect of the present invention provides a mounting system for an illuminable article assembly configured to be mounted between the front and rear wheel wells of a vehicle, the mounting system comprising first mounting means attached to the front wheel well; second mounting means attached to the rear wheel well; an elongated illuminable article having one end attached to the first mounting means and another end attached to the second mounting means; wherein a light source is maintained by at least one of said first and second mounting means, such that light emitted from the light source illuminates the illuminable article.

One or more objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a cross-sectional view of a lighting device utilizing a simulated neon light tube assembly of the present invention with one representative embodiment of an optional protective retaining cover shown in phantom.

FIG. 2 is a side elevational view of another representative embodiment of a protective retaining cover in accordance with one concept of the present invention, with a portion of another representative embodiment of the simulated neon light tube assembly encased therein.

FIG. 3 is an exploded view of one embodiment of the light tube assembly of the present invention.

FIG. 4 is a partial side elevational view of another representative embodiment of a simulated neon light tube assembly having ornamental indicia attached thereto.

FIG. 5 is a rear perspective view of a vehicle having various embodiments of the simulated neon light tube assembly of the present invention extending externally from the vehicle.

FIG. 6 is a partial side elevational view of a simulated neon light tube assembly having a modified retaining cap disposed thereon.

FIG. 7 is a cross-sectional view of a mounting assembly with a simulated neon tube assembly disposed therein, taken along the line 7-7 in FIG. 8.

FIG. 8 is a cross-sectional view of the mounting assembly and a plurality of simulated neon light tube assemblies taken along line 8-8 in FIG. 7.

FIG. 9 is a cross-sectional view of a lighting device having a retainer cover having a solid illuminable core.

FIG. 10 is a perspective view of an alternative embodiment for mounting the light tubes as an illuminated bed rail.

FIG. 11A-B are elevational views showing the various retention supports utilized by the mounting system shown in FIG. 10.

FIG. 12A is a perspective view of a modified retention support.

FIG. 12B is a top cross-sectional view of the modified retention support shown in FIG. 12A.

FIG. 12C is an elevational view of a supplemental light for use with the modified retention support shown in FIG. 12A.

FIG. 13 is an elevational view of an alternative embodiment for mounting the light tube near the rocker panel of a vehicle.

### DETAILED DESCRIPTION OF THE INVENTION

One representative embodiment of a lighting device according to the concepts of the present invention is generally designated by the numeral 10 in FIG. 1 and may include a handle or base portion, generally designated by the numeral 12, and an elongated, simulated neon light tube assembly, generally designated by the numeral 14. In the embodiment shown, one end 16 of the light tube assembly 14 is received within a tube-receiving end 18 of the base portion 12 and is removably attachable to the base portion 12 by any means known in the art such as, for example, by frictional fit. Alternative embodiments where the light tube assembly 14 is removable from the base portion 12 provide for screwing the light tube assembly 14 into the base portion 12 or vice versa, for sliding the light tube assembly 14 into the base portion 12 via frictional fit and maintaining the frictional fit via the use of an O-ring and/or a set screw, or for snapping the light tube assembly 14 into the end 18 of the base portion 12, either through the end 18 or by opening at least a portion of the base portion 12 and inserting the end 16 of the light tube assembly 14 into the base portion 12, such that the opened portion of the base portion 12 is then closed around the light tube assembly 12. For the purposes of the discussion that follows it should be understood that the term “light tube” also includes illuminable articles, such as light guides, solid light guides, hollow light guides, light pipes or any other suitable guide of light.

The base portion 12 can be made of essentially any material known in the art, including but not limited to wood, metal, plastic, polymeric material, and combinations thereof. It may also be formed into essentially any shape known in the art that satisfies the requirements of the light tube assembly 14. Where the lighting device 10 is to be held and manipulated by a user, the handle or base portion 12 should be suitable for gripping with a hand or hands. As such, it may be substantially cylindrical and of a diameter suitable for gripping.

Base portion 12 is preferably hollow and, as such, includes at least one cavity 20 for receiving various components to be used in conjunction with the light tube assembly 14. Within cavity 20, a power source 22 such as, for example, a battery or batteries, and a light source 24 such as, for example, a light bulb, a xenon flash tube, a high intensity discharge (HID), a laser, or a light emitting diode (LED), may be disposed. Cavity 20 may include multiple compartments such as, for example, a single compartment for each component disposed within the base portion 12, or may provide one compartment for inclusion of all components within the base portion 12. Other components used for the production of light for illuminating the light tube assembly 14 may also be included within the handle or base portion 12, including, for example, a heat sink 26 for radiating heat away from certain components in the handle or base portion 12.

Access to the components within the handle or base portion 12 may be attained by any means known in the art, including for example a threaded screw cap 28 with spring 30 for holding the power source 22 in place. It will be appreciated that other types of caps, such as snap-on caps, or those with frictional fit connections may be used instead of a threaded screw cap 28. Essentially any suitable means of affixing known in the art may be used, and it is preferable that the cap 28 be affixed to the base portion 12 in such a manner as to create a waterproof seal. Spring 30 would essentially be used to retain the power source 22 in positive engagement with the electrical circuit provided by the spring 30 and a switch SW. Another means of access to the power source 22 and other components within the handle portion 14 includes, but is not limited to, the use of a compartment door (not shown) made a part of the side wall 32 of the handle or base portion 12. Essentially, any know method for accessing the one or more compartments inside the handle or base portion 12 that do not interfere with the function of the lighting device can be used.

The power source 22 may be operatively connected to the light source 24 by any means known in the art so as to effectuate the lighting of the device 10. In the embodiment shown in FIG. 1, the light source 24 is connected to the power source 22 via a switch, designated SW, to open or close the power circuit to the light source 24 for illuminating or de-illuminating, respectfully, the light tube assembly 14. Essentially any type of switch SW can be used for the present invention, including a remotely controlled switch. In the embodiment shown, the switch SW is of a push button type with wires 34 connecting the power source 22 to the light source 24, but should not be limited thereto. There may be more than one switch if necessary and desired in order to allow the user to have greater interaction with the lighting device 10. Moreover, the switch SW could be internal or external of the handle or base portion 12 and include mechanisms well known in the art that would allow it to perform electronic operations other than on-off operations for the light source 24.

As will become apparent from further reading of the specification, alternative embodiments of the present invention also allow for alternate power sources, such as, but not limited to, solar power sources, to be located on or around the outside of the base portion 12 and to communicate with the light source 24 via means of a power cord, a rechargeable adapter, a plug (all not shown) and/or other means for connecting the light source 24 to a power source. The power source 22 should, however, provide sufficient power to the lighting source 24 to enable the light source to provide light sufficient to illuminate the light tube assembly as desired for a significant period of time. The power source 22 may also be used to provide power to any other electronic mechanisms that may be incorporated into the lighting device 10 such as, for example, sound devices (not shown).

Connected to the light source 24 is an optional heat sink 26 that draws or “sinks” heat away from the light source 24 when it is in active operation. By using the heat sink 26, in conjunction with a base portion 12 that is formed from metal such as steel or aluminum, the efficiency of transfer of heat from the light source 24 may be enhanced. The heat sink 26 is preferably connected to the bottom of the light source 24, and to the interior of the cavity 20, using heat transferring epoxy or adhesive that has sufficient thermal transfer properties suitable for application in the present invention. Alternatively, the heat sink 26 could be connected within the cavity 20 using other fastener means including screws, or a threaded connection between the heat sink 26 and the interior cavity 20.

Essentially any light source 24 suitable for providing light to and capable of emitting enough light to illuminate the light tube assembly 14 may be used in the present invention. For example, one or more light emitting diodes (LEDs) can be used and may be held in place by the metal heat sink 26. If an LED, such as 36 is used, it is preferably the high power type. One advantage of the use of LEDs is that LEDs can emit colored light, thereby providing colored light to the light tube assembly 12, without the use of a color filter or other means for changing the color of the light emitted. Furthermore, more than one LED can be used to emit multiple colors of light, or a single LED can be used with multi-colored dies on the same LED. To that end, the switch SW can be adapted to select the desired color of light to be emitted. For example, where one blue LED and one red LED is employed, the switch can be operated to select either the blue one, thereby producing a blue color in the light tube, or the red one, thereby producing a red color in the light tube, or both, thereby producing a purple color in the light tube.

Alternatively, one or more light bulbs can be used. It is envisioned that essentially any light bulb, including, for example, incandescent bulbs, halogen bulbs, HID bulbs and xenon flash tubes, can be used. When these bulbs, as well as LEDs are used however, it is preferable to include at least a reflector and, more preferably, to use a lens such as collimating lens for gathering and focusing the light in a controlled direction toward the light tube assembly 14. In practice, the collimating lens includes a first lens 38 for initially focusing the light emitted from the LED 36 outwardly onto the optional curved dish reflector 40, which redirects the light toward the light tube assembly 14. Thus, dish reflector 40 advantageously may include a reflective coating or an otherwise polished, smooth surface as a part of the collimating lens to make the collimating lens more efficient in redirecting light that may be reflected or refracted back towards the light source 24 or radially outward. The reflective coating or polished back side of the collimating lens also helps reflect light back up the tube that has been reflected back toward it as described below.

The light source used, while preferably disposed within the base portion 12, may be aligned directly with the light tube assembly 14, or may be aligned indirectly with the light tube assembly 14, through the use of mirrors, prisms, and other components capable of redirecting and focusing the light emitted from the light source toward the end 16 of the light tube assembly 14. In any event, the light source 24 is aligned in a manner that light emitted from the light source 24 will travel to the light tube assembly 14.

The light source 24 and collimating lens 38,40 may be separated from the light tube assembly 14 in some manner so that the light tube assembly 14 does not push on or contact the light source 24, lens 38 or reflector 40 directly and/or so that water or debris does not contact the light source 24, although in some embodiments all these elements may be molded together. Advantageously, the handle or base portion 12 containing the power source 22 and light source 24 could be made water-proof. The present embodiment shown in FIG. 1 depicts a divider 42 that may be molded or otherwise securely affixed into place between the collimating lens or reflector 40 and the light tube assembly 14. Divider 42 preferably is made of a clear, transparent material such as clear plastic or polymeric material and covers the entire circumferential cross-sectional area of the handle or base portion 12 between the collimating lens 40 and the light tube assembly 14 in order to maintain a water proof light source compartment. The divider 42 may be flat or have a lens shape to it in order to focus the light through the light tube assembly 14. Alternatively, if a water proof divider is not necessary, the divider 42 may simply be part of a ridge 44 around the periphery of the collimating lens/reflector 40 to prevent contact between the light tube assembly 14 and the lens/reflector 40. Of course, yet another alternative embodiment would have no divider at all.

It will be further appreciated that the light source 24, including the LED 36, the lens 38, and the reflector 40, and all other components within the lighting device 10, may be positioned within the base portion 12 at any angle desired. If angled in any manner other than directly at the light tube assembly 14, the light emitted from the LED will be focused more to one side of the light tube assembly 14. This will have the effect of making one part of the light tube assembly brighter than some other part of the light tube assembly 14, which may be preferable in some instances. If the light source 24 is angled in such a manner, then it may also be preferable that the divider 42 also be angled.

Where needed or desired, a color filter 46 may be used to illuminate the emitted light from the light source 24 at a particular wavelength or color for illumination within the light tube assembly 14. Such a color filter 46 is shown in FIG. 1 as positioned between the divider 42 and light tube assembly 14. It will thus be appreciated that, in one embodiment, the color filter 46 may be attached to the end 16 of the light tube assembly 14 for placement in the handle or base portion 12. Alternatively, it may be a separate piece to be placed into the tube-receiving end 18 of the handle or base portion 12 prior to attachment of the light tube assembly 14 to the base portion 12. The color filter 46 may be permanently affixed to the divider 42 or to the light tube assembly 14, if necessary, by any means known in the art, including via the use of an adhesive. The color filter 46, like the divider 42, should be translucent or transparent to allow light through it to the light tube assembly 14, thereby providing the light tube assembly 14 with the desired light. Also, like the divider 42, it may be angled, flat or have a lens shape for focusing the light through the light tube assembly 14.

Unlike prior art versions of similar lighting devices, the simulated neon light tube assembly 14 in the present invention as shown in FIG. 1 is selectively removable from the handle or base portion 12 of the lighting device 10. In some instances set forth below with respect to modified versions of other elements associated with the light tube assembly, a simulated neon light tube assembly similar to that set forth in U.S. Pat. No. 6,726,350 or U.S. application Ser. No. 10/792,249 (currently pending) may be irremovably affixed within the handle or base portion 12, depending upon the application and desired function of that light tube assembly. However, in the representative embodiment shown in FIG. 1, the simulated neon light tube assembly 14 is selectively removable as by frictional fit to the handle or base portion 12.

As more particularly shown in FIGS. 1 and 3, the simulated neon light tube assembly 14 of the present invention includes an elongated tube 50 of clear plastic or other translucent, suitably rigid material capable of illumination upon operation of the light source 24. However, it is alternatively envisioned that the light tube assembly 14 may have fluorescent or coloring dyes and/or coloring agents added to the plastic or polymeric material to provide added color, if desired. Such coloring of the light tube assembly may interact with different colors from the light source 24 or other components affecting the color of the light transmitted to the light tube assembly such that, once illuminated, the light tube assembly 14 is provided with a unique and aesthetically desired effect. Furthermore, the light tube assembly 14 may have two-dimensional or three-dimensional visible indicia or lenses (not shown) molded on either the inner surface 52 or the outer surface 54 of the tube 50. As shown, the light tube 12 is cylindrical in shape and is, therefore, circular in cross-sectional configuration. However, the light tube may take any cross-sectional configuration known in the art and should not necessarily be limited to the shape shown in the drawings. The end 16 of the light tube assembly 14 should, however, be compatible, in size, shape and configuration, with the tube-receiving end 18 of the base portion 12.

In order to create the simulated neon lighting appearance desired for the light tube assembly 14 of the present invention, the simulated neon light tube assembly 14 includes a diffusing film 60 of the type described and disclosed in U.S. Pat. No. 6,726,350 and U.S. application Ser. No. 10/792,249, currently pending, the disclosures of which are incorporated herein by reference, disposed within the tube 50 against the inner surface 52 thereof. Generally, this diffusing film 60 may be made of any material suitable for imparting a neon lighting-like effect to the light tube assembly 14 when light is produced from the light source 24, and is preferably a thinly rolled sheet or layered sheets of polished or otherwise reflective and refractive plastic selected from the group consisting of acetate, vinyl, polyethylene, polypropylene, cellophane and polyester. More particularly, the diffusing film 60 may, for example, have a single sheet thickness of from about 0.001 inches to about 0.004 inches that is then rolled, layered, or otherwise disposed against the inner surface 52 of the tube 50 so as to have a total thickness of from about 0.031 inches to about 0.375 inches around the inner periphery of the tube 50, depending upon the material used as the diffusing film. If desired, the diffusing film 60 may also be etched, foil stamped, or otherwise have indicia placed thereon for commercial appeal.

The diffusing film 60 may be inserted into the tube 50 and positioned against the inner surface 52 of the tube 50 during manufacturing of the tube 50 by sliding the film 60 into the tube 50 from either end 16, 56 of the tube 50 prior to capping the tube 50 and/or inserting the light tube assembly 14 into the handle or base portion 12. In the representative embodiment, the diffusing film 60 extends essentially the entire length of the tube 50 and encompasses the entire inner periphery of the tube 50, and may be held in place by any means known in the art, such as by end caps 62, 64.

Being elongated, the tube 50 has two ends 16, 56, one (16) of which is selectively and removably attached to the handle or base portion 12 as described previously, and the other (56) of which extends away from the handle or base portion 12 and light source 24, both of which, for purposes this embodiment, are closed or capped for reasons set forth below. The end (16) proximate the handle or base portion 12 and/or the light source 24 is closed as, for example, by a cap 62 attached to and disposed at that end 16 of the tube 50. Essentially any configuration of the cap 62 can be used to close the end 16 of the tube 50 as desired. The only requirements for the cap 62 is that it be at least partially translucent and, more preferably, transparent, and that it adequately contain the diffusing material inside the tube 50, thereby separating the diffusing film 60 from the light source 24 and allowing light to be received into the tube 50.

The cap 62 may be molded, fused, ultrasonically welded, sealed, screwed, adhered or otherwise attached to the end 16 of the tube 50 by any suitable means known in the art. The cap 62 is preferably made of a clear or transparent plastic or polymeric material similar to that of the divider 42 or of the tube 50 itself so as to permit light from the light source 24 to be transmitted through it and into the tube 50. The cap 62, too, may be flat or have a lens shape for focusing the light through the tube 50, if desired. In some instances, it may be desirable to provide a reflector or reflective coating, shown in phantom as 66 in FIG. 3, to the outer periphery of the distal side 68 of cap 62. The reflective coating 66 aids in redirecting any light that has been reflected back towards the light source 24 back into the tube 50.

The end 56 distal to the handle or base portion 12 and/or the light source 24 is also closed as by, for example, the cap 64 attached to and disposed at that end 56 of the tube 50. Like cap 62, essentially any configuration of the cap 64 can be used to close the end 56 of the tube 50 as desired. The requirements for this cap 64 is that a reflective material 70 be at least partially disposed thereon to at least partially reflect any light emitted from the light source 24 the reaches the end 56 of the tube 50 back through the tube 50. As shown, cap 64, which completely covers the end 56 of the tube 50, is completely covered with this reflective material 70.

The cap 64, likewise, may be molded, fused, ultrasonically welded, sealed, screwed, adhered or otherwise attached to the end 56 of the tube 50 by any suitable means known in the art. The cap 64 is preferably made of a plastic or polymeric material and, if the reflective material 70 is a coating or separate reflector from the cap 64, may be made from the same or similar translucent or transparent materials as the cap 62 or of the tube 50. In alternative embodiments, it may be desirable to permit light from the light source 24 to be at least partially reflected through cap 64 as later described. The cap 64 may be flat or curved and, as will be described in further embodiments of the present invention, may even have ornamental indicia associated with it. Thus, cap 64 may have any shape or configuration known in the art.

It should also be appreciated that the material used to form the caps 62,64, which has been previously discussed may be formed so as to include a plurality of molded transparent or partially transparent prisms therewithin. Alternatively, the reflective coating 66 and/or the reflective material 70 disposed upon the caps 62,64 may be replaced with a reflective and transparent or partially transparent material, or a prismatic material, such as a prismatic tape, such as that provided by 3M® for example. It should be appreciated that prismatic material as used by the embodiments discussed herein may be fully reflective, or may be both partially reflective and partially transparent. In one aspect, the reflective prismatic tape may include a prismatic material and a backing surface that may be any desired color, such as white, for example. It is also contemplated that a prismatic material comprising aluminum dioxide may also be utilized. When such prismatic tape having a prismatic surface and a colored backing surface is utilized, it may be disposed upon either side of any of the caps 62,64 such that the reflective prismatic surface is proximate the inner surface 52 of the light tube 50. As such, a portion of the light that is radiating through the light tube 50 is both reflected by the prismatic surface as well as transferred through the prismatic surface and/or the colored backing surface.

It should also be appreciated that the light tube 50 may comprise various sections prism that are molded, or otherwise integrated with the material that forms the light tube 50. That is, the prisms may extend from the outer surface 54 of the light tube 50, or may be integrated within the cross-section of the material comprising the light tube 50.

In addition to the above description of the light tube assembly 14, FIG. 1 illustrates, in phantom, the positioning of a protective retaining cover 72 over that portion of the light tube assembly 14 extending out of the handle or base portion 12. More particularly, the retaining cover 72 encases and protects the entire exposed portion of the light tube assembly 14 and is attached at one end 74 to a cover-receiving end 76 of the base portion 12. The protective retaining cover 72 may be selectively and removably attached to the base portion 12 by any means known in the art, and is shown as being attached by way of compatible threads disposed on the inside of end 74 of said retainer cover 72 and on the outside of cover-receiving end 76 of the base portion 12. Other means of removably attaching two components as previously set forth in this specification may alternatively be used, including but not limited to, snap-on fit or frictional fit of the components.

Retaining cover 72 preferably is made of a clear, transparent material such as clear plastic or polymeric material, much like the light tube assembly 14. In this manner, the light illuminating the simulated neon light tube assembly 14 remains visible to the user. Further, lenses, prisms, textures, artwork, indicia, coloring agents, and the like may be incorporated into or onto the retaining cover 72, if desired.

In an alternative embodiment, the simulated neon light tube assembly 14 may be disposed within a modified retaining cover 300, shown in FIG. 9. Specifically, the modified retaining cover 300 is substantially equivalent to the retaining cover 72, but maintains a transparent or partially transparent solid core 310 with an angled end 320. It should be appreciated that the core 310 may be formed from any colored or textured material, such as colored plastic, so as to form an illuminable side surface 321. Moreover, it should be appreciated that the material that forms the core 310 may be identical to the material used to form the light tube 50, but is not required. The angled end 320 includes an outer surface 322 that is distal to the inner surface 52 of the light tube 50 and an inner surface 334 that is proximate to the inner surface 52 of the light tube 50. Specifically, either of the respective outer and/or inner surfaces 322,324 may provide a polished and/or mirrored reflective surface and/or a painted and/or reflective coating that is configured to reflect light that is radiating from the end 56 of the light tube 50.

Alternatively, it is also contemplated that either of the outer and/or inner surfaces 322,324 of the angled end 320 may include material, such as prismatic material that both reflects and/or transmits a portion of light radiating within the light tube 50. In another aspect, molded prisms may be integrated within all or part of the core 310 or may be arranged as a layer that is adjacent the inner surface 324 of the core 310. Additionally, the molded prisms may be formed from any desired material, which may be colored using known techniques. As such, when the prismatic material, molded prisms or other partially transparent/partially reflective material is disposed upon the angled surface 320, a portion of the light emitted from the light source 24 and the light tube 50 is reflected out of the side surface 321, while another portion is allowed to pass through the angled end 320. It should also be appreciated that the molded prisms may have a mirrored surface that may be configured to reflect between 0 (fully absorbs) to 100% (fully reflective) of the light that is incident thereupon. In one aspect, the angled end 320 may have an angle of approximately 45 degrees with respect to horizontal, and allows the light transmitted by the light source 24 to be redirected by the transparent/reflective materials disposed upon the outer and/or inner surfaces 322,324 by about 90 degrees, causing the light to illuminate the side wall 321. Moreover, the modified retaining cover 300 encases and protects the entire exposed portion of the light tube assembly 14 and is attached at one end 74 to the cover-receiving end 76 of the base portion 12. Moreover, the modified retaining cover 300 may be selectively and removably attached to the base portion 12 by any means known in the art. For example, the modified retaining cover 300 may utilize threads disposed upon the inside end 74 of the retaining cover 300 that threadably mate with threads on the outside of the cover receiving end 76 of the base portion 12.

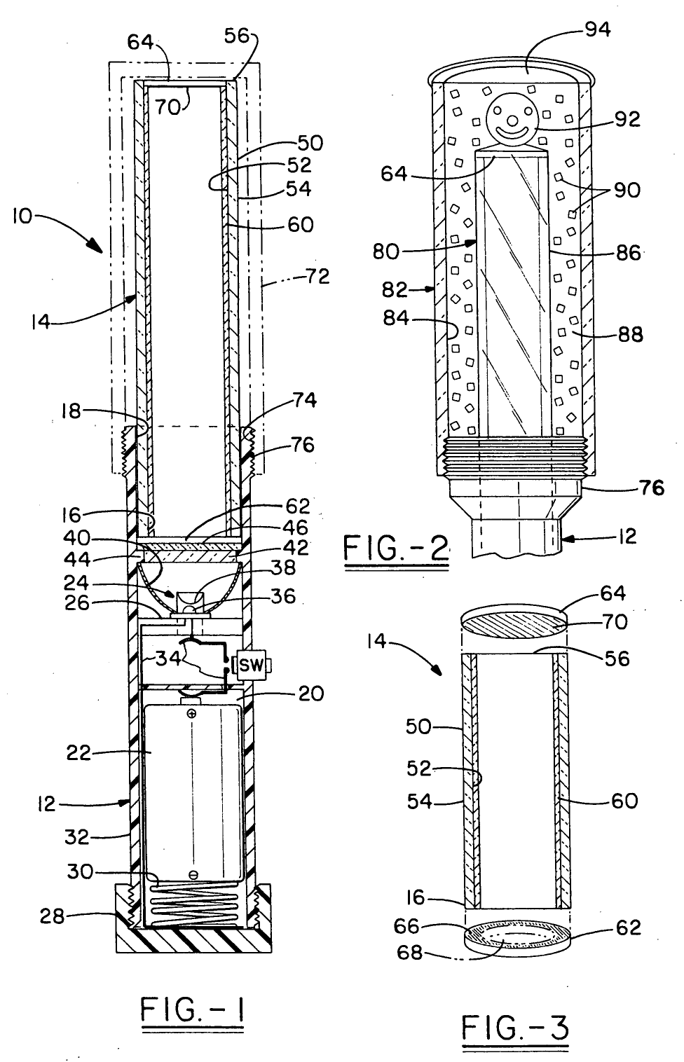

In an alternative embodiment, a simulated neon light tube 80 may be disposed within a much larger, modified retainer cover 82, as depicted in FIG. 2. In this embodiment, it will be appreciated that the cover-receiving end 76 of base portion 12 must be modified to substantially extended radially outwardly, or the circumference and diameter of the tube-receiving end 18 of the base portion 12 for receiving the light tube 80 must be substantially reduced, in order to provide a retaining cover 82 having a much larger circumference and diameter than the light tube 80 depicted. In so doing, however, space 88 is created between the inner surface 84 of the retaining cover 82 and the outer surface 86 of the light tube 80. If the sealing means between the base portion 12 and the retaining cover 82 is water-tight, then it will be appreciated that a non-gaseous fluid, such as water, mineral oil and the like, may be disposed within the space 88 created between the retaining cover 82 and the light tube 80. Moreover, various elements such as confetti 90 can be added to the water or other fluid to create a further aesthetically pleasing effect. For example, in this embodiment, when the user agitates the lighting device with the modified retaining cover 82 shown, the confetti 90 and/or other ornamental indicia are interspersed throughout the fluid in an aesthetically pleasing manner.

In addition to having a greater circumference and diameter, the retaining cover 82 may be substantially longer than the light tube assembly 14. This allows for various ornamental indicia such as figurine 92 to be added to the distal end of the light tube assembly 14. Such ornamental indicia 92 may be an integral part of the cap 64 closing that end of the light tube 80 or may be adhered to or otherwise fixedly attached to the cap 64.

Retaining cover 82 may take any form aesthetically pleasing for commercial sale. To that end, it is noted that the retaining cover 82 illustrated in FIG. 2 has a rounded end 94 as compared to the square-off end of the retaining cover 72 set forth in FIG. 1. Retaining cover 82 may also include a reflective material on its top to redirect any escaped light back towards the light tube assembly 14.

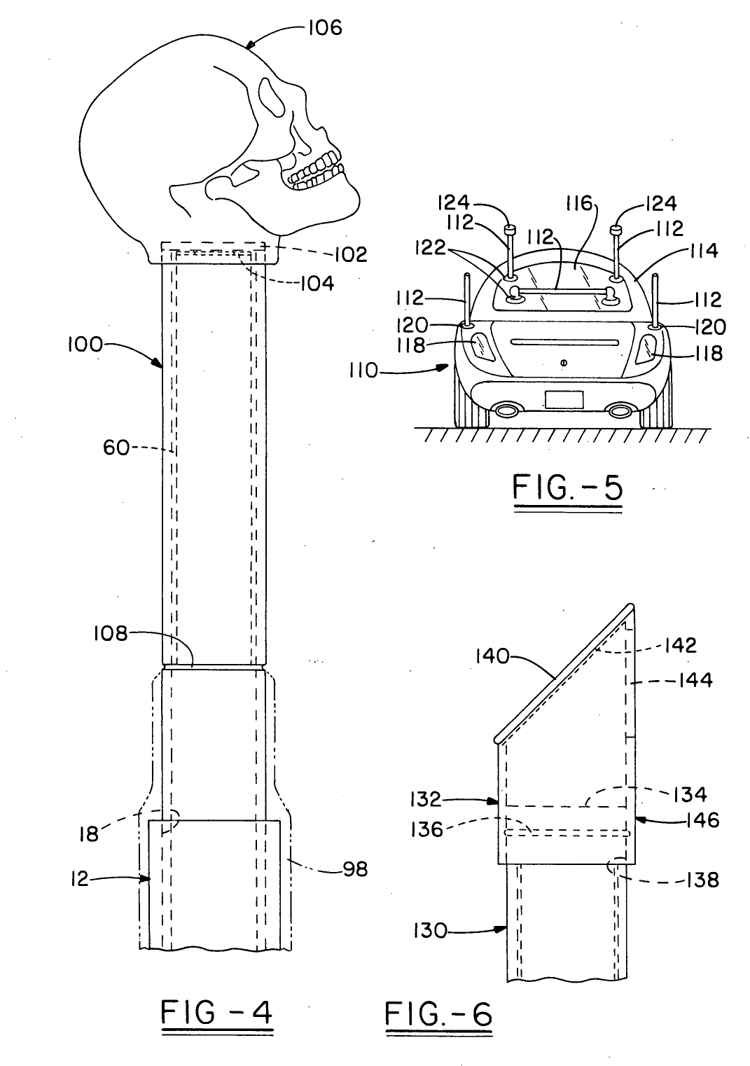

FIG. 4 discloses another embodiment of a light tube 100 of the present invention, wherein the light tube 100 has been modified with respect to its cap 102. In particular, cap 102 is made of a translucent or transparent plastic or other material that will permit light to shine therethrough. The cap 102 still includes a reflective material 104 on at least a portion of the cap 102, for reflecting at least a portion of the light transmitted to that end 56 of the light tube 100 back towards the light source. In the embodiment illustrated in FIG. 4, the reflective material 104 remains essentially around a substantial part of the outer periphery of the cap 102. However, because there is no longer reflective material covering the cap 102 completely, some light is transmitted from the light source, through the light tube 100 and into the ornamental indicia, such as figurine 106 attached to the light tube 100. The ornamental indicia 106 may have a plurality of reflective surfaces, opaque surfaces, and/or translucent surfaces that alter and transmit the received light through the ornamental indicia 106. Furthermore, the ornamental indicia 106 could be of any desired figure, such as a skull as shown, or another desired figure or feature. The ornamental indicia 106 may be attached to the light tube 100 using a frictional fit, a threaded connection, o-ring frictional fit, snap-on, set screw, or any other suitable means of attachment.

In addition to illustrating a modified cap for the present invention, FIG. 4 also illustrates that the diffusing film 60 need not extend the entire length of the light tube 100. That is, as shown, the diffusing film for providing a simulated neon lighting-like effect to the light tube 100 is provided in only a little over half of the light tube 100. In this embodiment, the diffusing film 60 ends at a break away score line 108. A break away score line may be used in the present invention for light tubes that are susceptible to breakage. Such a score line 108 is generally an etching or a small cut in the light tube 100 to provide the light tube with a convenient place to crack or otherwise break apart. That is, the light tube 100 may be scored to create a point of breakage when disposed within the base portion 12. Instead of several pieces, the score line may aid in having the light tube 100 break into only two or three pieces. Moreover, it will be appreciated that the score line is preferably positioned on the light tube 100 at a distance away from the tube-receiving end 18 of the base portion 12 such that, if the light tube 100 does break along the score line 108, the broken part remaining attached to the base portion 12 can be removed without much effort.

While primarily used for the purpose set forth above, it will be appreciated that score line 108 may have other uses as well. For example, it may be used to seat an optional O-ring (not shown) to be used under sleeve 98.

FIG. 4 illustrates the use of a sleeve 98 that may be fitted or stretched over a portion of the light tube 100 and the handle or base portion 12 to prevent water or other debris from entering the base portion 12 at end 18 thereof. The sleeve 98 may be made of rubber, a rubberized plastic, or a rubber-coated or rubber-lined metal or plastic that is preferably water-resistant or water-proof. It should be elastic enough to stretch or fit over the end 18 of the handle 12, and smooth enough to slide over the light tube 100 into its appropriate position.

Another alternative embodiment of the present invention is shown in FIG. 5, which utilizes modified light tube assemblies 112 for external or interior decorative or operative use on a motor vehicle, generally depicted as numeral 110 in the figure. Here, the base portion and light source (not depicted) are integrated into the body 114, windows 116, and lights 118, such as the brake lights, running lights, signal lights, and parking lights, of the vehicle 110, and may be operatively attached to the vehicle 110 by essentially any means known in the art and in accordance with the concepts of the present invention. This allows the light tube assembly 112 to be externally visible, thereby enhancing the vehicle's appearance and/or safety. Since each light tube assembly 112 is comprised of a self-contained, closed-ended reflective tube, the light tube assembly 112 can utilize pre-existing power and light sources already present on the vehicle, including those power and light sources retrofitted onto the vehicle 110, and for security and safety reasons, may be selectively removable from the vehicle 110.

For example, the power source can be the vehicle's battery. The vehicle already has electrical circuitry that will enable the installer of the light tube assembly 112 of the present invention to utilize the vehicle's battery as the power source for the light tube assemblies 112 in much the same way that other lighting devices on the vehicle utilize the electrical circuitry of the vehicle. The battery may be connected to the light source by various wires (not shown) as was previously described above.

In the present invention, the light source preferably should be a lighting fixture, e.g., an LED, a bulb, etc., separate and apart from the light source already employed on the vehicle, but may be easily installed to operate in the same electrical circuit as another light source have a similar purpose or operation, such as, for example, a brake light source, a parking light source, running light source, accessory light source, or a headlight source for the vehicle 110. Alternatively, one or more light tube assemblies may have their own, separate operational electrical circuit. In a preferred embodiment, the self-contained light tube assembly 112 to be received within the tube-receiving end 18 of a base portion retrofitted or otherwise provided on vehicle 110 can be integrated into a part of the vehicle having an existing housing, such as, for example, a brake light housing 118 provided by the vehicle 110 such that the base portion is a apart of the existing housing. The light tube assembly 112 can then provide additional light and illuminate in conjunction with the brake light. Advantageously, should the existing brake light or other light source be obscured from view or be unable to sufficiently transmit light, the light tube assemblies 112 of the present invention may be more visible.

Where a separate light source is not employed with the light tube assemblies 112 of the present invention, it is often the case that the light source used will not be appropriately aligned with one or more of the light tube assemblies 112 for proper function of the light tube assemblies. In this case, a fiber optic cable, or a light pipe (not shown) may be used to route or redirect the light from the existing light source to the appropriate end of the light tube assembly 112 disposed within a base portion 120 located within the vehicle 110, to provide adequate light to the light tube assembly 112.

Where there is no existing housing for integrating or retrofitting the light tube assembly 112, such as in windows 116 and the like, a base 122 may be retrofitted into the window 116. Such a base 122 will include at least a light source contained therein for emitting light necessary for illuminating the light tube assembly 112. Such a base 122 will include the light source which may be disposed on the inside of the window 116 as well as the cover plate for holding the light tube assembly 112 on the outside of the window 116. The base may or may not include a power source and, where a power source is not included, wires or other external electrical circuitry may be used to operatively power the light source therein.

The light tube assemblies 112 may include ornamental indicia and figurines on them as previously described. For example, FIG. 5 shows a large end cap 124 as ornamental indicia at the end of the light tube assemblies extending upwardly from the window 116 of the vehicle 110. This ornamental indicia 124 may be attached to the light tube assemblies 112, and may or may not have light passing through to each of them, as was previously described in this specification.

FIG. 6 discloses yet another embodiment of a light tube of the present invention, wherein the light tube 130 has been modified with respect to its cap 132. Instead of having a cap that is irremovably attached to the light tube, the cap 132 in this embodiment is selectively removable from an end 134 of the light tube 130 by friction fit with an O-ring 136 or other previously described attachment means. That is, a tube-receiving end 138 of the cap 132 receives the end 134 of light tube 130 in much the same manner as was described for tube-receiving end 18 of base portion 12 receiving the end 16 of light tube assembly 14.

In this instance however, the end 134 of light tube 130 is open. While a end-closing cap may still be disposed at the end 134 of the light tube, if necessary, to contain the diffusing film 60 therein, any such end-closing cap must contain light transmitting apertures that allow light to pass from the light tube 130 through that cap and into the cavity of cap 132. Thus, light traveling through light tube 130 will continue pass the end 134 of the tube 130 and toward an angled end 140 of the cap 132. Angled end 140 includes a reflector or reflective coating 142 thereon, like the reflectors or reflective materials previously described, to reflect or redirect the light in a desired manner. The cap 132, including angled end 140, may be formed from the same materials as that of the light tube 130 or from other materials suitable to the need of the user.

More particularly, the cap 132 includes an angled end 140 that has a like angled reflector 142 that reflects the light, transmitted into the cap 132 from a light source emitting light from the other end of light tube 130. The reflector 142 may be formed from chrome, polished foil, or any other reflective material known in the art. Additionally, in lieu of using a reflector 142, the angled end 140 may be texturized or coated to give the angled end 140 reflective properties. By changing the angle of the end 140, the cap 132 may be able to redirect incoming light, from the light source, in any desired direction, including through a lens or prism 144 in the side wall 146 the cap 132. For example, FIG. 6 shows an angled end 140 having an angle of approximately 45 degrees that may be used for aesthetic, as well as functional purposes. When used in conjunction with a brake light for a vehicle, it will be appreciated that cap 132 having an angled end 140 of approximately 45 degrees allows the light transmitted by a light source, such the brake light of the vehicle 110, to be redirected by the reflector 142, by about 90 degrees, causing the light to illuminate the cap side wall 146 and/or the lens 144 therein. Where the lens or prism 144 is oriented toward the rear of the vehicle 140, it will be appreciated that the modified cap 132 acts essentially like another brake light.

In another aspect, it is also contemplated that the cap 132 may be configured to have a solid transparent or semi-transparent core 350 which is configured in a manner that is equivalent to the core 310 discussed above with regard to the embodiment discussed with respect to FIG. 9. The angled end 140 which includes an inner and outer surface 360,370 may also utilize any combination of reflective material, mirrored surfaces, polished surfaces, transparent/reflective material, and prismatic material which may be fully reflective or partially reflective and partially transparent. In addition, the core 350 may also include molded prisms and/or transparent materials configured within the core 350 in any manner that has been discussed herein. As such the use of the solid core 350 enables the cap 132 to present an enhanced illumination effect.

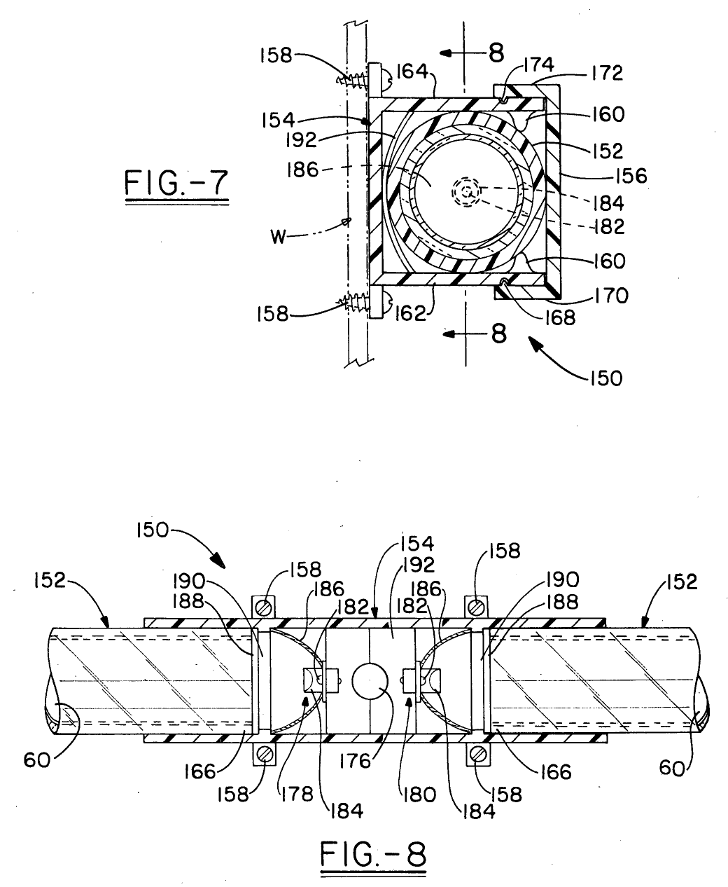

Another embodiment of the present invention is shown in FIGS. 7 and 8, wherein a mounting assembly, generally indicated by the numeral 150 in FIGS. 7 and 8, is disclosed. Mounting assembly 150 is capable of mounting one or more light tube assemblies 152 to any mounting surface, including a wall or ceiling, designated W in FIG. 7. The mounting assembly 150 generally comprises a mounting bracket 154 and a retaining cover 156. The mounting bracket 154 may be attached to the desired mounting surface W such as by screws 158 shown in FIGS. 7 and 8, or by any other means of attachment including but not limited to: nails, adhesive, and adhesive tape. The means of attaching a mounting assembly such as 150 to a mounting surface W is commonly known and may be carried out without undue experimentation.

The mounting bracket 154 is dimensioned to sufficiently support and stabilize the light tube assemblies 152, and permits a user to remove and replace the light tube assemblies 152 within the bracket 154, as often as necessary. Essentially any means for placement of the light tube assemblies 152 into the mounting bracket 154 can be used. However, in a preferred embodiment shown in FIG. 7, the mounting bracket 154 may optionally include one or more retaining ridges 160 for snap fitting the light tube assemblies 152 into place. More particularly, the mounting bracket 154 includes two extending and opposed arms 162,164 that receive the light tube assemblies 152 therebetween. These arms 162 and 164 include the inwardly directed retaining ridges 160 near the open end of the mounting bracket 154 such that, when a light tube assembly 152 is presented between the arms 162 and 164, the arms flex outward and may snap back to receive the light tube assembly 152 and notify the installer of the placement of the tube assembly 152 within the mounting bracket 154. The retaining ridges 160 protrude inward to prevent the light tube assembly 152 from escaping from the between the arms 162 and 164 through the open side of the mounting bracket 154. As shown in FIG. 8, the mounting bracket 154 preferably retain only the ends 166 of the light tube assemblies 152, thereby allowing the light illuminating the tube assemblies to be seen.

The retaining cover 156 is used to cover the open side of the mounting bracket 154 and to secure the ends 166 of the light tube assemblies 152 within the mounting assembly 150 once the tubes have been positioned therein. The retaining cover 156 may be removably attachable to the mounting bracket and, specifically, to the arms 162, 164 of the mounting bracket 154, by any means known in the art. In the preferred embodiment, the retaining cover 156 includes inwardly directed ribs 168 on the ends of the legs 170, 172 of the retaining cover 156 that act in cooperation with outwardly exposed notches 174 in the arms 162, 164 of the mounting bracket 154 to snap fit or otherwise removably attach the retaining cover 156 to the mounting bracket 154. In an alternative embodiment, it is contemplated that the retaining cover 156 may be connected or attached to the mounting bracket 154 by a hinge at the end of one of the legs 170 and the snap-fit rib 168 disposed at the other leg 172 of the retaining cover 156. Other alternatives include attaching one leg 170 of the retaining cover 156 to one arm 162 of the mounting bracket 154 such as by means of an adhesive or the like, by frictional fit, or to make the retaining cover 156 and the mounting bracket 154 integral with each other via a hinge-like molding.

Mounting bracket 154 and retaining cover 156 may be made of the same or different materials and may be made from essentially any material known in that art suitable for the functions and purposes of the present invention. The materials may be clear, but are preferably opaque to cover the other components included in the mounting bracket described below. The mounting bracket 154 and retaining cover may be made from plastic, metal or another suitably rigid, yet flexible material.

As shown in phantom is FIG. 8, the mounting bracket 154 may further include an aperture 176 therein to provide access through the bracket 154 and the mounting surface W to wires (not shown) as may be necessary for operative connection of one or more light sources 178, 180 disposed within the mounting assembly 150 to a power source. Using such an aperture 176 to provide access to the wall or other mounting surface allows the mounting bracket 154 to be mounted flush to the mounting surface W when a power cord is used to supply power to the light source(s).

Mounting assembly 150 further includes one or more light sources 178, 180 disposed within the mounting bracket 154 between the opposed arms of the bracket 154 and are protected against the outside environment by retaining cover 156. Light sources 178, 180 may be of any type light source previously described, and are shown as having LEDs 182 and oppositely directed collimating lens 184 and reflector dishes 186 for dispersing light in opposite directions to two different light tube assemblies 152. The light sources 178, 180 may be powered by an external power source (not shown) such as a residential power from an electrical outlet, or may be powered by any other suitable power source as previously discussed. The light sources 178, 180 are mounted and aligned in opposing directions to allow the light emitted from each source to enter a light tube assembly 152 through a light receiving end cap 188 disposed on the end of each light tube assembly when the light tube assemblies are inserted in the mounting assembly 150. An optional divider 190 may also be connected protect the light source and/or to enhance the illumination properties of the light tube assemblies 152. It is also contemplated that a switch (not shown) can be provided that allows a user of the present invention to turn the light source(s) on and off.

As shown in the preferred embodiment, behind each light source 178, 180 is one or more heat sinks 192, which transfer heat away from the light sources 178, 180, when the present invention is in operation. These heat sinks 192 may take any form known in the art and, in fact, may even extend around the light source to the extent that the heat sink may extend behind the light tube assemblies 152 and, more particularly, between the light tube assembly and the fixed mounting surface W. In that case, and as more particularly, shown in FIG. 7, the heat sink 192 may be used as an additional reflector for directing light toward that part of the light tube assembly exposed farthest away from the mounting surface W. The heat sinks 192 may extend to any desired length or dimension desired within the mounting assembly 150.

Additionally, the heat sink 192 can be made from any suitable material known in the art, such as steel or aluminum, that has heat transferring or “sinking” properties and can be mounted within the mounting bracket 154 using known means in the art, such as thermally conductive adhesive. While shown as being close together, the heat sinks 192 are typically spaced apart by a gap of at least approximately 1 inch (2.54 cm), to provide adequate heat transfer away from the light sources 178, 180. However, the dimension of the heat sinks 192 can be increased to extend into any gap created, according to the operating temperature and operating parameters of the light source 178, 180. Any gap may be filled with air, foam, or any other material that is not an efficient thermal conductor.

The mounting assembly 150 of the present invention may be of any size, shape and dimension suitable for use with the light tube assemblies 152. The light tube assemblies 152 utilized in the mounting assembly 150 preferably include diffusion film 60 disposed against the inner surface of the light tube assemblies as discussed, but for this embodiment, it will be understood that such diffusion film may not be necessary. Typically, light tube assemblies 152 may have a length ranging from about 6 inches to about 8 feet or more. Typical mounting assemblies 150 may have a length of about 1 to 6 inches or more, depending upon the length of the light tube assemblies used therewith. The mounting assemblies 150 may be opaque or have semi-translucent indicia or coloring applied to them in any arrangement on the inside or outside surfaces of the light tube assemblies 152. Whatever the construction, the mounting assemblies 150 and light tube assemblies 152 should offer an aesthetically pleasing appearance to a user when the light tube assemblies 152 are illuminated. The end caps 188 of the light tube assemblies 152 may also be angled or beveled as previously described to allow light transmitted through the light tube 152 to reflect and/or refract at different angles, adding to the appearance of the present invention when illuminated.

The light tube assemblies 152 may also be adapted for use with multiple bases or light sources, such that the tube assemblies 152 may be provided in series, with each light tube assembly having both of its ends encased in opposed mounting assemblies 150 for holding each light tube assembly in place.

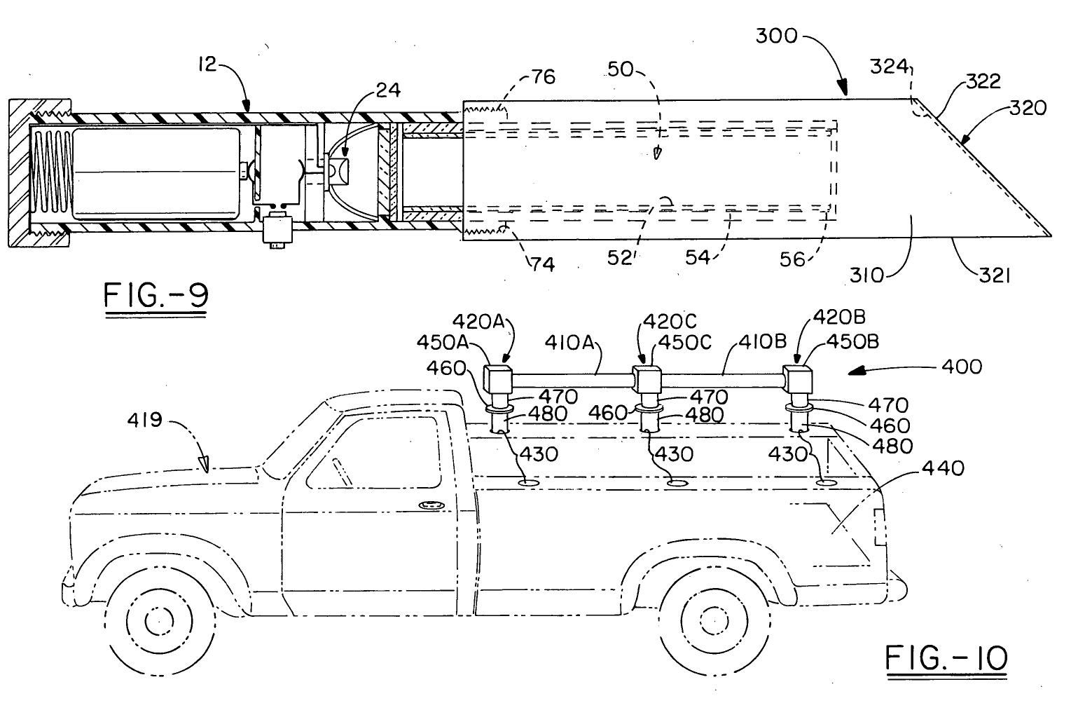

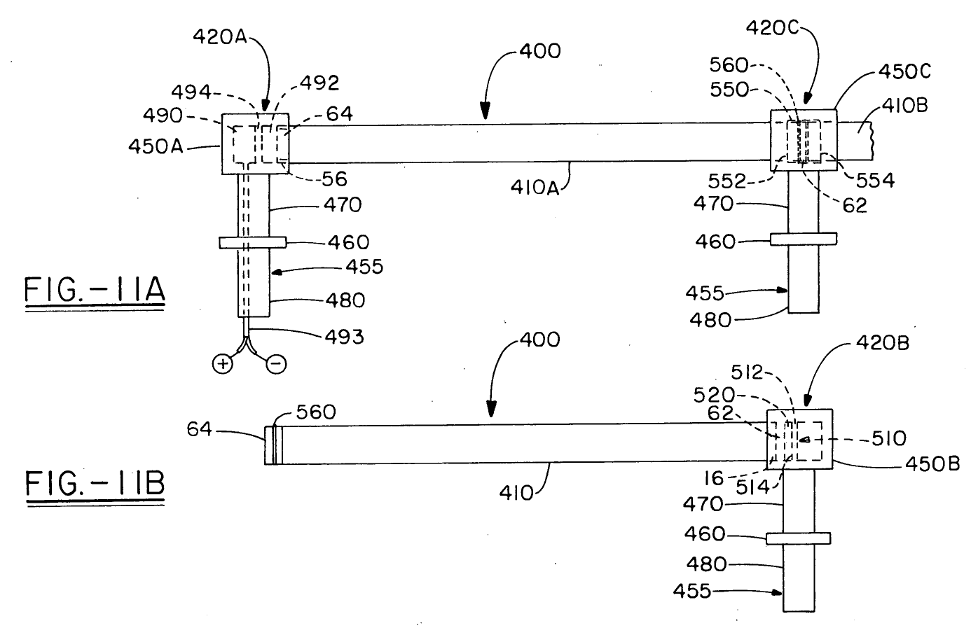

In another embodiment, a mounting system 400 for attaching one or more light tubes 410 to a vehicle 420 is shown in FIG. 10 and more clearly in FIGS. 11A-B. While the mounting system 400 may be used in any desired manner, the discussion that follows is directed primarily to its use with vehicles, such as trucks or pick-up type trucks with a cargo bed. It is generally known that a pick-up truck 420, or similar utility-type trucks, maintain a plurality of stake post holders or retaining cavities 430 that are disposed about the perimeter of a bed 440 maintained by the vehicle 420. To allow the light tubes 410 designated “A” and “B” to be attached to these retaining cavities 430 so as to give the appearance of illuminated bed rails, the mounting system 400 utilizes various retention supports including a lighted retention support 420A, a reflective retention support 420B, and a coupling retention support 420C shown more clearly in FIGS. 11A-B. The retention supports 420A-C may be formed from any suitable material such as plastic or metal for example. The retention supports 420A-C comprises respective support sections 450A-C that are configured to be mounted to the retaining cavities 430 by a mounting member 455 that extends from the support sections 450A-C. The mounting member 455 comprises a stopper 460, a riser section 470, and a mounting section 480 to be discussed. The stopper 460 is separated from the support sections 450A-C by the riser section 470. Extending from the stopper 460 in a direction opposite that of the riser section 470 is the mounting section 480, which is dimensioned to be received by the retaining cavities 430 maintained by the vehicle 420. The stopper 460 may be spaced from the support sections 450A-C by the riser section 470 by any desired distance, so long as the length of the riser section 470 is the same for each retention support 420A-C being used on a particular light tube mounting application. In addition, the stopper 460 is dimensioned so that it is larger than the opening of the retaining cavities 430 to ensure that the retention supports 420A-C maintain the predetermined height established by the riser section 470. Specifically, the support sections 450A-C are each configured to provide different functions in addition to their support and mounting functions, which will be described in detail below.

The support section 450A, shown in FIG. 11A comprises a light source 490. The light source 490 may comprise any suitable source of light, such as those discussed with respect to the various embodiments presented herein. As such, the light source 490 is positioned so that light emitted thereby is directed out of a mounting cavity 492 configured to slideably receive and align an end 56 of the light tube 410 therewithin. The light source 490 may be powered by any suitable power source, for example, the light source 490 may be powered by the electrical system maintained by the vehicle 420 via wires 493. In addition, a collimating lens 494 may also be optionally disposed adjacent the light source 490 so that light emitted from the light source 490 passes therethrough. It should also be appreciated that the cap 64 is at least partially transparent to allow the light to pass into the light tube 410.

The support section 450B, shown in FIG. 11B, comprises a mirror assembly 510. The mirror assembly 510 comprises a reflector 512 having a mirrored surface 514 that faces outward toward the opening of a retention cavity 520. It should be appreciated that the end 16 of the light tube 410 that is inserted into the retention cavity 520 has an end cap 62 that is transparent or partially transparent and/or partially reflective so that light is able to pass through the end cap 62 so as to be incident on the mirrored surface 514 allowing it to be reflected back down the light tube 410 to provide a neon-like lighting effect. As such, when either end of the light tube 410 is placed within the retention cavity 520, the mirrored surface 514 of the reflector 512 results in any light passing through an end 530 of the light tube 410 adjacent the reflector 512 being reflected back into the light tube 410. It should also be appreciated that the reflector 512 may comprise molded prisms, prismatic material, or any other material which has been discussed above with regard to the other embodiments of the light tube.

The support section 450C, shown in FIG. 11A, comprises a coupling sleeve 550 that has opposed openings 552,554 dimensioned so as to receive one end 16,56 from each of two light tubes 410, allowing their ends to be abutted, allowing them to be joined and supported. As such, the coupling sleeve 550 of the support section 450C allows multiple light tubes, such as light tubes 410A and 410B to be consecutively coupled together as shown. As such, it should be appreciated that the caps 62,64 that abut when two light tubes 410 are inserted into the coupling sleeve 550 are at least partially transparent to allow light to pass between each light tube 410A and 410B so that they may be illuminated uniformly as a single unit so as to form a continuous illuminated rail.

In order to mount one or more light tubes 410 to the retaining cavities 430 provided by the bed 440 of the vehicle 420, the retention supports 420A-C may be used together in any desired combination, as long as at least one lighted retention support 420A is used to provide light to illuminate the light tubes 410 mounted therewith. In other words, the retention supports 420A-C can be mixed in any desired manner so long as at least one lighted retention support 420A is utilized so a to provide source of light. As such, the discussion that follows relates to the mounting of two light tubes 410A, 410B as shown in FIG. 10. However, it should be appreciated that any other configuration may be utilized. As such, the mounting section 480 of the coupling retention support 420C is placed in the center retention cavity 430, while the mounting section 480 of the lighted retention support 420A is placed in the left retention cavity 430, and the mounting section 480 of the reflective retention support 420B is placed in the right retention cavity 430. Next, one light tube 410A is mounted, such that one end of the light tube 410A is placed within the mounting cavity 492 of the retention support 420A and the other end of the light tube 410A is placed within the opening 554 of the coupling sleeve 550 maintained by the retention support 420C. The second light tube 410B is mounted, such that one end of the light tube 410B is placed within the retention cavity 520 of the retention support 420B and the other end of the light tube 410B is placed within the opening 552 of the coupling sleeve 550 maintained by the retention support 420C. An O-ring 560 may be placed upon each of the ends 16,56 of the light tubes 410A-B so as to provide a suitable amount of compressive force to prevent the mounted light tubes 410A-B from moving or potentially falling out of the support sections 450A-C. Furthermore, the O-ring 560 also provides other benefits including to assist in preventing dirt, water, as well as other debris and the like from entering the barrier formed by the O-ring 560. Thus, when each of the light tubes 410A-B are mounted in the manner discussed, light is emitted from the light source 490 maintained by the retention support 420A and is directed through the light tubes 410A and 410B where it is incident upon the mirrored surface 514 of the reflector 512 so as to illuminate each of the light tubes 410A and 410B. As such, when the light tubes 410 are mounted via the mounting system 400 the appearance of an illuminated bed rail is presented.

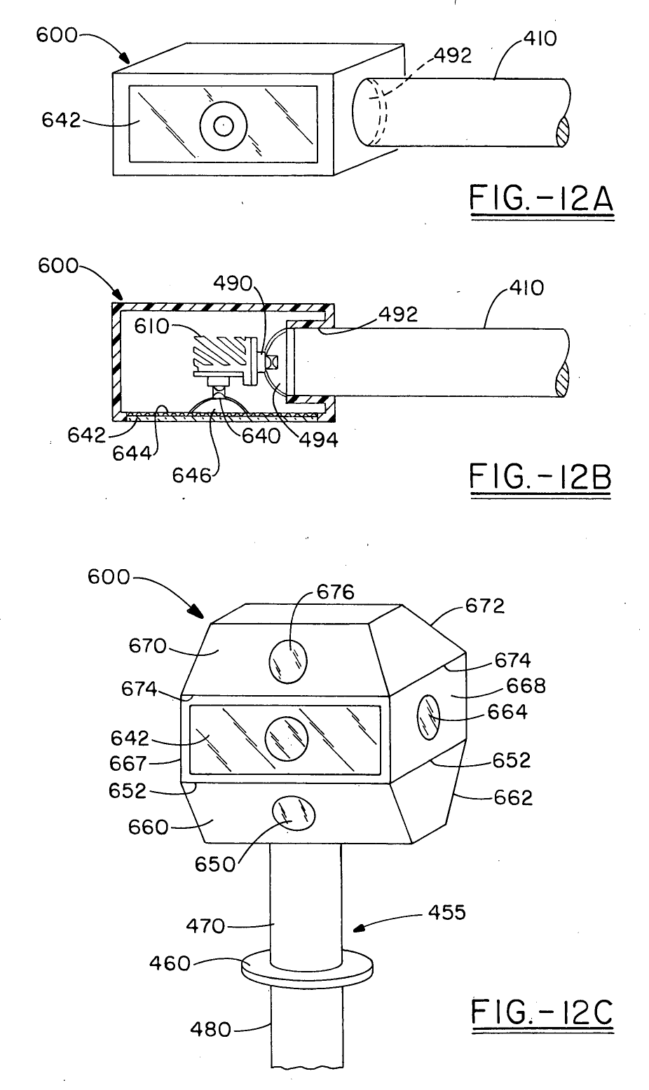

In addition, the lighted retention support 420A of the mounting system 400 may utilize a modified retention support 600 in place of the support section 450A, as shown in FIGS. 12A and 12B. The modified retention support 600 includes the light source 490 that is coupled with a suitable heat sink 610 to adequately cool the light source 490 when it is illuminated. In addition, the light source 490 may comprise any suitable light source, such as high-power LED (light emitting diodes), and may be powered in a manner equivalent to that discussed above with regard to the retention support 420A, and the other embodiments discussed herein. The light source 490 is configured so that the emitted light is directed out of the mounting cavity 492 that is dimensioned to receive the ends of the light tube 410. It is also contemplated that the collimating lens 494 is adjacent the light source 490, so that the light emitted thereby passes through the lens 494 out of the mounting cavity 492 and into the end of the light tube 410. In addition, auxiliary light source 640 may also be disposed within the modified retention support 600 and associated with corresponding transparent or at least partially transparent reflector 642. The reflector 642 may be formed from molded transparent, partially transparent, colored or other suitable material, which may include molded prisms 644 within its interior surface. In addition, the reflector 642 may also include a collimating lens 646 that is integrated, or otherwise molded, into the material forming the reflector 642, and which is aligned with the light emitted by the light source 640. As such, the use of the collimating lens 646 increases the intensity of the light emitted therefrom as compared to the areas of the reflector 646 that surround it. It should also be contemplated that the light sources 490 and 640 may be wired in a known manner into the electrical system of the vehicle 420 so as to allow each of the auxiliary lights to be illuminated when the various safety, auxiliary, warning, back-up, running, blinker, marker, brake, and/or hazard lights that are actuated. As such, the modified lighted retention support 600 may be used with any of the other retention supports 420A-C previously discussed so as to form an illuminated bed rail maintained by the vehicle 420.

In addition, the modified retention support 600 may also be configured to include one or more supplemental light 650 shown in FIG. 12C. The supplemental lights 650 may comprise any suitable light source discussed herein, such as LEDs, or any source of light discussed herein. The supplemental light 650 is mounted on a beveled or angled section 660 that projects downward from an underside edge 652 of the modified retention support 600. As such, the beveled section 660 allows the supplemental light 650 to emit, or otherwise project light away from the vehicle 420 toward the ground. Such light is beneficial when the operator of the vehicle 420 is in the process of changing his or her tire at night for example. It is also contemplated that one or more additional supplemental lights (not shown) may provided on a beveled section 662 that is opposite that of the beveled section 660. Such supplemental light may be used to provide illumination to the bed 440 of the vehicle 420. It should also be appreciated that the retention support 600 may also include a brake light 664 that maintained by one or both end surfaces 667 and 668 of the retention support. Additionally, the brake light 664 may be wired into the electrical system of the vehicle 420 so as to illuminate when the brakes are actuated. It should be appreciated that the brake light 664 may utilize a reflector, such as that using molded prisms to enhance the illumination effect provided thereby.

While the beveled or angled section 660 may extend below the retention support 600, it is also contemplated that the retention support 600 may include beveled or angled sections 670,672 that projects upward from an upperside edge 674 of the retention support 600. The beveled sections 670,672 are configured to house one or more supplemental lights, such as supplemental light 676 which is maintained by the beveled section 670 shown in FIG. 12C.

It should also be appreciated that the various angled sections 660,670, as well as the end surfaces 667,668 of the retention support 600 may include in any desired combination any other light, including work lights, puddle lights and the like.

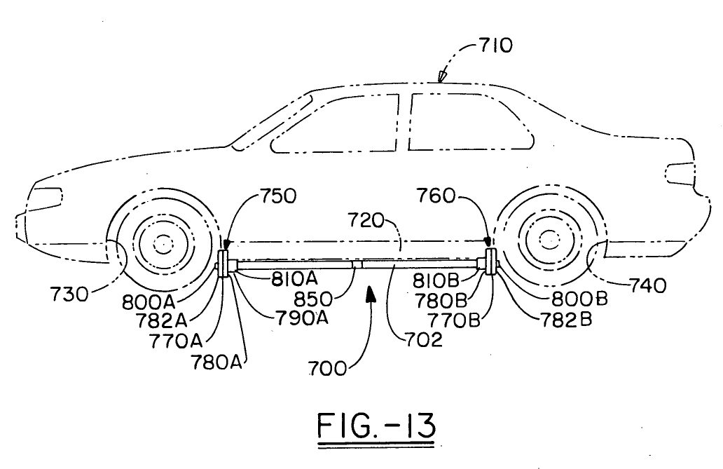

In another embodiment, an alternative mounting system 700 for mounting the light tube assembly 702 to a vehicle 710 is shown in FIG. 13. It is commonly known that the vehicle 710, which may comprise an automobile for example, maintain a pair or rocker panels, one of which is identified with numeral 720, which span between the front and rear wheel wells 730,740 along each of the bottom sides of the vehicle 710. For the purposes of the following discussion the term “wheel well” includes not only wheel wells found on vehicles, but also includes those structures that are proximate to the wheel well that are suitable for mounting the mounting system 700 thereto.

The mounting system 700 is configured so that it enables the light tube assembly 702 to be mounted near the rocker panel 720 using front and rear flap mounts 750 and 760 so as to provide a visual accent thereto. Because the flap mounts 750 and 760 are structurally equivalent, only flap mount 750 will be discussed, as such the components of flap mount 750 are identified with the designation “A” and components of flap mount 760 are identified with the designation “B.” Specifically, the flap mount 750 includes a flap 770A that may be formed from any suitable material, including plastic, metal, or the like. The flap 770A may also be contoured to suitably conform to the surfaces of the vehicle 710 to which the flap mount 750 is attached to provide a pleasing appearance. In addition, the flap 770A has a mounting surface 780A and a backing surface 782A. The mounting surface 780 provides a housing 790A that is dimensioned so as to retain a light source 700A. It should be appreciated that the housing 790A may be formed of the same or different material as that of the flap 770A. In addition, the housing 790A maybe made integral with the flap 750 or the housing 790A may be separate and mounted to the mounting surface 780A using known techniques, including but not limited to adhesive, screws, hook and loop, bolts, thermo-welding, snap-fit, compression fit, or any other known suitable means of fixation. In one aspect, the housing 790A may be attached to the mounting surface 780A by a threaded stud that is attached at one end to the housing 790A which is dimensioned to extend through the thickness of the flaps 750 and is configured to receive a fastener, such as a nut or bolt to thus hold the housing 790A in place. Disposed within and/or on a portion of the housing 790A is a light source 800A, while another portion of the housing comprises a mounting cavity 810A is dimensioned so as to receive an end of the light tube 702. Alternatively, the end of the light tube 702 may be dimensioned and/or the outer perimeter of the mounting cavity 710 may be dimensioned so that the interior volume of the light tube 702 may receive a transparent plug (not shown). Opposing and separated from the front flap 750 by the rocker panel 720 is the back flap 760, which provides the housing 790B which is configured so it is horizontally aligned with the housing 790A when the flap mounts 750,760 are attached to the vehicle 710. The spaced housings 790A-B maintained by the front flap 750 and the rear flap 760 allows the light tube 702 to be mounted such that each end of the light tube 702 is received within respective mounting cavities 810A-B. Once mounted, the light tube 702 is configured and aligned with the light sources 800A-B so as to receive the light emitted therefrom. As such, the flap mounts 750,760 are configured so as to be respectively mounted to respective front and rear wheel wells 730,740 so as to maintain the illuminable article 702 near or proximate to the rocker panel 720 so as to impart an enhanced illuminated appearance thereto.

Additionally, it is also contemplated that in lieu of the flaps 770A,770B that the flap mounts 750 and 760, may utilize a bracket (not shown) that maintains a light source and a light tube retention means, such as those discussed herein. The bracket may be essentially any desired shape that may be mounted to the wheel wells of the vehicle 710 using any suitable manner of fixation, such as those discussed above for the flaps 770. As such, the retention means and the light source are oriented with respect to each other, such that the light tube 702 is illuminated when it is mounted to the vehicle 710, so as to provide an enhanced lighting effect thereto.

It is also contemplated that optionally disposed within the light tube 702 is a reflector 850, such as a reflective disk for example, that may be configured with a polished and/or mirrored surface, or with molded prisms, prismatic material or any other desired reflective and/or transparent or partially transparent material. The reflector 850 may be held in place using any suitable means, including adhesive, set screws, as well as the compressive force imparted to the reflector 850 from two or more sections of light diffusing material 60 that sandwiches the reflector 850. The reflector 850 serves as a light valve, by allowing a portion of light to pass through it, while reflecting a portion of light away from it. In addition, the reflector 850 may be configured to reflect or absorb all light incident upon it.

While the invention has been described in complete detail and pictorially shown in the accompanying drawings it is not to be limited to such details, since many changes and modifications may be made to the invention without departing from the spirit and the scope thereof. Hence, it is described to cover any and all modifications and forms that may come within the language and scope of the attached claims.

What is claimed is:

1. A lighting device comprising:
a base portion;
at least one light source disposed within the base portion for emitting light; and
an elongated light tube having one end attached to the base portion and disposed proximate the light source such that light emitted from the light source will illuminate the light tube, the light tube having an inner surface, the light tube including:
a light diffusing film disposed against the inner surface of the tube the diffusing film having a rolled total wall thickness from about 0.031 inches to about 0.375 inches;
a first cap disposed on an end of the tube distal to the light source;
a second cap disposed on the end of the tube proximate to the light source and closing that end of the tube allowing light to be received into the tube, wherein the first cap and the second cap encase the light diffusing film within the tube; and
a removable cap having a solid at least partially transparent core having an angled end aligned with the light source, the removable cap including a tube receiving end opposite the angled end configured to selectively receive an end of the light tube distal the light source.

2. The lighting device of claim 1, wherein the angled end includes a prismatic material.

3. The lighting device of claim 2, wherein the prismatic material is formed from aluminum dioxide.

4. The lighting device of claim 2, wherein the prismatic material is colored.

5. The lighting device of claim 2, wherein the prismatic material includes a colored backing.

6. The lighting device of claim 1, wherein the angled end includes molded prisms that are integral with the core.

7. The lighting device of claim 1, wherein the first cap includes a prismatic material.

8. The lighting device of claim 1, wherein the first cap includes a plurality of prisms that are integral therewith.

9. A lighting device comprising:
a base portion;
at least one light source disposed within the base portion for emitting light; and
an elongated light tube having one end attached to the base portion and disposed proximate the light source such that light emitted from the light source will illuminate the light tube, the light tube having an inner surface, the light tube including:
a light diffusing film disposed against the inner surface of the tube the light diffusing film having a rolled total wall thickness from about 0.031 inches to about 0.375 inches;
a first cap disposed on an end of the tube distal to the light source; and
a second cap disposed on the end of the tube proximate to the light source and closing that end of the tube, allowing light to be received into the tube, wherein the first cap and the second cap encase the light diffusing film within the tube; and
a retaining cover having an elongated solid at least partially transparent core with an angled end, the retaining cover configured to be removably attached to the base portion, such that when attached the angled end is aligned with the light source, and the cover encases a portion of the light tube exposed from said base portion.

10. The lighting device of claim 9, wherein the angled end includes a prismatic material.

11. The lighting device of claim 10, wherein the prismatic material is formed from aluminum dioxide.

12. The lighting device of claim 10, wherein the prismatic material is colored.

13. The lighting device of claim 10, wherein the prismatic material includes a colored backing.

14. The lighting device of claim 9, wherein the angled end includes molded prisms that are integral with the core.

15. The lighting device of claim 9 wherein the first cap includes a prismatic material that allows the light received from the light tube to be both reflected and transmitted therethrough.

16. The lighting device of claim 9, wherein the first cap includes a plurality of prisms integral therewith.

17. A mounting system for mounting an illuminable article assembly to a vehicle having a plurality of retaining cavities, the system comprising:
a plurality of retention supports, at least one of which houses a light source, each retention support configured to be mounted within one of said retaining cavities;
an elongated illuminable article disposed proximate the light source, such that light emitted from the light source will illuminate the illuminable article and having a first end maintained by one retention support, and a second end maintained by a second retention support.

18. The mounting system of claim 17, wherein the retention support housing the light source maintains one end of the elongated illuminable article.

19. The mounting system of claim 18, wherein each retention support housing the light source comprises:
a support section comprising a mounting cavity configured to receive an end of the illuminable article; and
a mounting member configured to be received within one of the retaining cavities of the vehicle.

20. The mounting system of claim 19, wherein the mounting member comprises:
a stopper for maintaining the height of the retention support on the vehicle;
a riser section coupled between the support section and one side of the stopper; and
a mounting section extending from another side of the stopper.

21. The mounting system of claim 18, wherein the support section further comprises:
an auxiliary light source; and
a collimating lens integral with a reflector, wherein the auxiliary light source illuminates the reflector.

22. The mounting system of claim 19, wherein the reflector maintains a plurality of prisms that are integral therewith.

23. The mounting system of claim 18, further comprising an angled section that extends from an underside edge of the support section, the angled section housing one or more supplemental lights.

24. The mounting system of claim 17, wherein at least one of the retention supports is a reflective retention support comprising:
a support section having a mounting cavity configured to receive an end of the illuminable article and housing:
a reflector configured to reflect light received from the light source; and
a mounting member configured to be received within one of the retaining cavities of the vehicle.

25. The mounting system of claim 24, wherein the mounting member comprises:
a stopper for maintaining the height of the retention support on the vehicle;
a riser section coupled between the support section and one side of the stopper; and
a mounting section extending from another side of the stopper.

26. The mounting system of claim 17, wherein at least one of the retention supports is a coupling retention support comprising:
a support section comprising a coupling sleeve that has first and second opposed openings configured to receive the at least one illuminable article; and
a mounting member configured to be received within one of the retaining cavities of the vehicle.

27. The mounting system of claim 26, wherein the mounting member comprises:
a stopper for maintaining the height of the retention support on the vehicle;
a riser section coupled between the support section and one side of the stopper; and
a mounting section extending from another side of the stopper.

28. A mounting system for an illuminable article assembly configured to be mounted between the front and rear wheel wells of a vehicle, the mounting system comprising:
first mounting means attached to the front wheel well;
second mounting means attached to the rear wheel well;
an elongated illuminable article having one end attached to the first mounting means and another end attached to the second mounting means;
wherein a light source is maintained by at least one of said first and second mounting means, such that light emitted from the light source illuminates the illuminable article.

29. The mounting system of claim 28, wherein the first mounting means comprises a front flap mount comprising:
a front flap; and
a front housing maintained by the front flap, the front housing maintaining a front mounting cavity configured to receive one end of the illuminable article.

30. The mounting system of claim 29, wherein the front housing maintains the light source configured to emit light into the end of the illuminable article.

31. The mounting system of claim 28, wherein the second mounting means comprises a rear flap mount comprising:
a rear flap; and
a rear housing maintained by the rear flap, the rear housing maintaining a rear mounting cavity configured to receive one end of the illuminable article.

32. The mounting system of claim 31, wherein the rear housing maintains the light source configured to emit light into the end of the illuminable article.

33. The mounting system of claim 28, further comprising a reflector disk disposed within the illuminable article so as to reflect the light emitted by the light source.

34. The mounting system of claim 28, wherein said illuminable article includes a plurality of prisms integrated therewith.
